(19) United States
(12) Patent Application Publication
(10) Pub. No.: US 2026/0270359 A1
(43) Pub. Date: Sep. 10, 2026

(54) INFORMATION PROCESSING SYSTEM AND METHOD AND NON-TRANSITORY COMPUTER READABLE MEDIUM

(71) Applicant: FUJIFILM Business Innovation Corp., Tokyo (JP)

(72) Inventors: Atsushi MORI, Kanagawa (JP); Masahiko HARADA, Kanagawa (JP); Kiyoshi YASUKAWA, Kanagawa (JP); Yusuke TAGUCHI, Kanagawa (JP); Akira SHINADA, Kanagawa (JP); Yuji ONOZAWA, Kanagawa (JP)

(73) Assignee: FUJIFILM Business Innovation Corp., Tokyo (JP)

(21) Appl. No.: 19/307,884

(22) Filed: Aug. 22, 2025

(30) Foreign Application Priority Data
Mar. 10, 2025 (JP) 2025-037819

(51) Int. Cl. H04N 1/32; H04N 1/00

(52) U.S. Cl. CPC H04N 1/32299; H04N 1/0087

(57) ABSTRACT

An information processing system includes a processor configured to: obtain a scanned image from an image processing device, the scanned image being generated by scanning a document in the image processing device; and cause, if it is detected from the scanned image that the document is a confidential document, a display to display information regarding whether execution of confidential document processing is permitted or prohibited in accordance with a right granted to a user having scanned the document using the image processing device.

### CROSS-REFERENCE TO RELATED APPLICATIONS

This application is based on and claims priority under 35 USC 119 from Japanese Patent Application No. 2025-037819 filed Mar. 10, 2025.

### BACKGROUND

### (i) Technical Field

The present disclosure relates to an information processing system and method and a non-transitory computer readable medium.

### (ii) Related Art

Japanese Unexamined Patent Application Publication No. 2010-11303 discloses a technology for preventing unauthorized copying of copy prohibited information and managing copy prohibited information in an image forming system connected to a network.

### SUMMARY

To restrict processing to be executed for a confidential document, an image processing device makes determination regarding processing to be executed for a confidential document, such as determining whether a document is a confidential document or determining whether printing or scanning of a confidential document is permitted or prohibited. Determination regarding whether a document is a confidential document involves advanced image processing, such as analyzing a scanned image and detecting a special mark, for example, contained in the scanned image. Determination regarding whether printing or scanning of a confidential document is permitted involves checking of authorization granted to a user. This makes it necessary for the image processing device to communicate with a server via a network, such as the internet.

The image processing device thus requires advanced processing capabilities and an internet connection function. Image processing devices without such capabilities and function may fail to execute the above-described processing operations.

Aspects of non-limiting embodiments of the present disclosure relate to reducing the processing burden on an image processing device by a greater degree than the configuration in which determination regarding processing to be executed for a confidential document is made by the image processing device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: obtain a scanned image from an image processing device, the scanned image being generated by scanning a document in the image processing device; and cause, if it is detected from the scanned image that the document is a confidential document, a display to display information regarding whether execution of confidential document processing is permitted or prohibited in accordance with a right granted to a user having scanned the document using the image processing device.

### BRIEF DESCRIPTION OF THE DRAWINGS

An exemplary embodiment of the present disclosure will be described in detail based on the following figures, wherein:

FIG. 1 is a block diagram illustrating an example of the schematic configuration of a system;

FIG. 2 is a block diagram illustrating the hardware configuration of an image processing device;

FIG. 3 illustrates server information;

FIG. 4 illustrates Wi-Fi-related information;

FIG. 5 is a block diagram illustrating the hardware configuration of a user terminal;

FIG. 6 illustrates user information;

FIG. 7 is a block diagram illustrating the hardware configuration of a server;

FIG. 8 illustrates user information;

FIG. 9 is a first flowchart illustrating a procedure of specific processing;

FIG. 10 is a second flowchart illustrating the procedure of specific processing;

FIG. 11A illustrates a visual image for explaining an execution process of image processing in the user terminal;

FIG. 11B illustrates an example of a detection table;

FIG. 12 is a third flowchart illustrating the procedure of specific processing;

FIG. 13 is a fourth flowchart illustrating the procedure of specific processing;

FIG. 14 illustrates a visual image for explaining an execution process of generation processing of a new prohibition mark in the user terminal;

FIG. 15 is a fifth flowchart illustrating the procedure of specific processing;

FIG. 16 illustrates a visual image for explaining an execution process of generation processing of feature information in the user terminal;

FIG. 17 is a sixth flowchart illustrating the procedure of specific processing;

FIG. 18A illustrates a visual image for explaining an execution process of image processing in the user terminal and the image processing device; and

FIG. 18B illustrates an example of calculation information.

### DETAILED DESCRIPTION

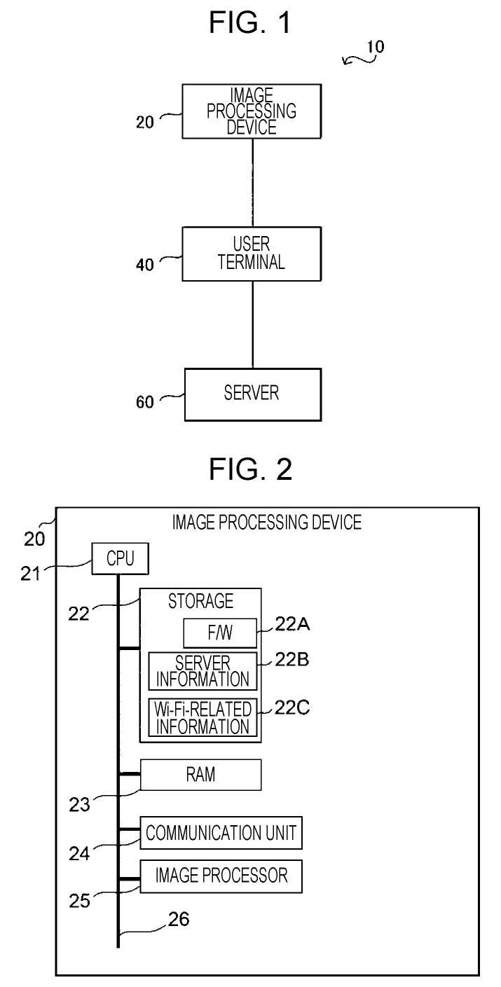

A system 10 according to an exemplary embodiment will be described below. FIG. 1 is a block diagram illustrating an example of the schematic configuration of the system 10.

As illustrated in FIG. 1, the system 10 includes an image processing device 20, a user terminal 40, and a server 60. The user terminal 40 can communicate with each of the image processing device 20 and the server 60.

FIG. 2 is a block diagram illustrating the hardware configuration of the image processing device 20. As illustrated in FIG. 2, the image processing device 20 includes a central processing unit (CPU) 21, a storage 22, a random access memory (RAM) 23, a communication unit 24, and an image processor 25. These elements are connected to each other via a bus 26 so as to communicate with each other.

The CPU 21 executes various programs and controls the individual elements of the image processing device 20.

The storage 22 is constituted by a storage device, such as a hard disk drive (HDD), a solid state drive (SSD), or a flash memory, and stores various programs and various pieces of data. For example, in the storage 22, firmware (F/W) 22A, server information 22B, and Wi-Fi (registered trademark)-related information 22C are stored.

The RAM 23 serves as a work area and temporarily stores a program or data. For example, the RAM 23 temporarily stores the F/W 22A.

The communication unit 24 is an interface for allowing the image processing device 20 to communicate with another device. For this communication, for example, wired communication standards, such as Ethernet (registered trademark) or fiber distributed data interface (FDDI), or wireless communication standards, such as near field communication (NFC), Wi-Fi, 4G, 5G, or a local area network (LAN), are used.

The image processor 25 has various functions for executing image processing. In the exemplary embodiment, the image processor 25 executes at least printing and scanning of a document.

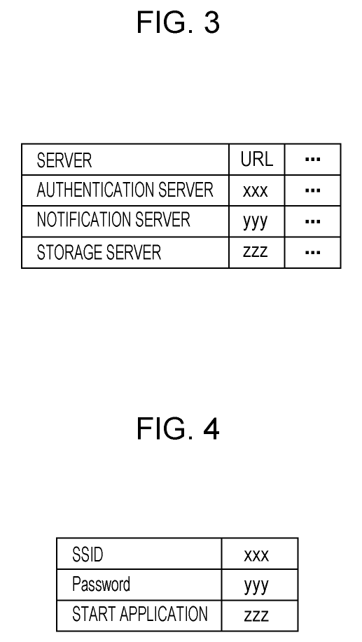

FIG. 3 illustrates the server information 22B. As shown in FIG. 3, the storage 22 stores uniform resource locators (URLs) of various servers 60, such as an authentication server, a notification server, and a storage server, as the server information 22B, and also stores other information, such as user registration information.

FIG. 4 illustrates the Wi-Fi-related information 22C. As shown in FIG. 4, the storage 22 stores various items of information, such as a service set identifier (SSID), a password, and a start application, as the Wi-Fi-related information 22C.

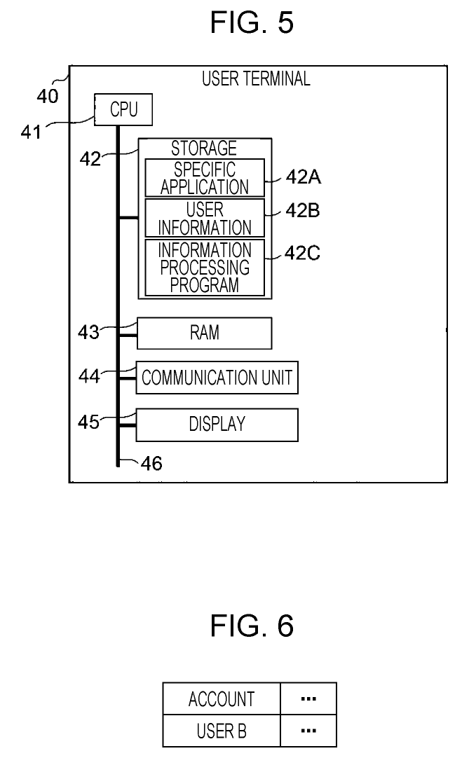

The SSID is the name for identifying a Wi-Fi access point to be connected. The password is an authentication password for connecting to the Wi-Fi access point. The start application is information for specifying an application to be automatically started after connecting to the Wi-Fi. In one example, in the exemplary embodiment, a specific application 42A (see FIG. 5), which will be discussed later, is specified as the start application.

FIG. 5 is a block diagram illustrating the hardware configuration of the user terminal 40. The user terminal 40 is a smartphone, for example.

As illustrated in FIG. 5, the user terminal 40 includes a CPU 41, a storage 42, a RAM 43, a communication unit 44, and a display 45. These elements are connected to each other via a bus 46 so as to communicate with each other.

The CPU 41 executes various programs and controls the individual elements of the user terminal 40. The CPU 41 is an example of a processor of an exemplary embodiment of the disclosure.

The storage 42 is constituted by a storage device, such as an SSD or a flash memory, and stores various programs and various pieces of data. For example, in the storage 42, the specific application 42A, user information 42B, and an information processing program 42C are stored. The specific application 42A is an application for allowing the user terminal 40 to make determination regarding processing to be executed for a confidential document, such as determining whether a document is a confidential document or determining whether printing or scanning of a confidential document is permitted or prohibited. The information processing program 42C is a program for causing the CPU 41 to execute various processing operations, which will be discussed later.

The RAM 43 serves as a work area and temporarily stores a program or data. For example, the RAM 43 temporarily stores the specific application 42A.

The communication unit 44 is an interface for allowing the user terminal 40 to communicate with another device. For this communication, for example, wireless communication standards, such as NFC, Wi-Fi, 4G, or 5G, are used.

The display 45 is a liquid crystal display or an organic electroluminescence (EL) display and displays various items of information. The display 45 integrally includes a touchscreen. The display 45 is an example of a display of an exemplary embodiment of the disclosure.

FIG. 6 illustrates the user information 42B. As shown in FIG. 6, the storage 42 stores user account information and authentication-related data, for example, as the user information 42B. The user account includes a user ID, an email address, and identification information, for example, used by an authentication system.

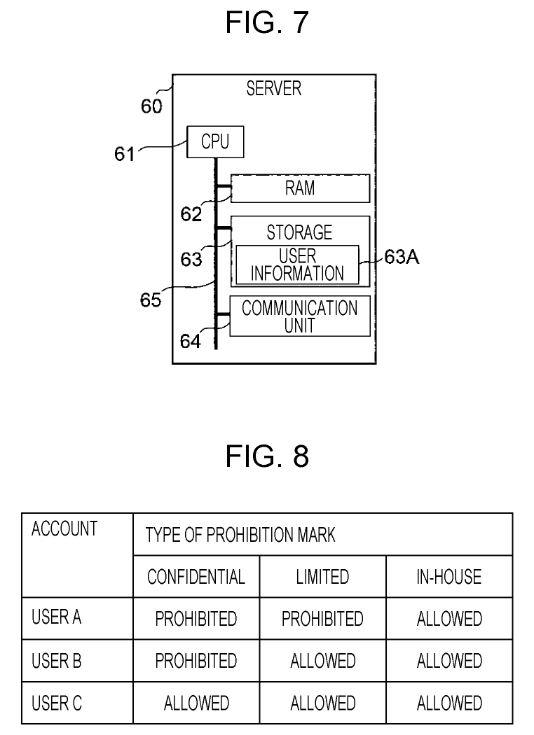

FIG. 7 is a block diagram illustrating the hardware configuration of the server 60. The system 10 includes various servers 60, such as the authentication server, notification server, and storage server. The basic configurations of these servers are the same and the authentication server will be explained below as an example of the servers 60.

As illustrated in FIG. 7, the server 60 includes a CPU 61, a RAM 62, a storage 63, and a communication unit 64. These elements are connected to each other via a bus 65 so as to communicate with each other.

The CPU 61 executes various programs and controls the individual elements of the server 60.

The RAM 62 serves as a work area and temporarily stores a program or data.

The storage 63 is constituted by a storage device, such as an HDD or an SSD, and stores various programs and various pieces of data. For example, in the storage 63, user information 63A is stored.

The communication unit 64 is an interface for allowing the server 60 to communicate with another device. For this communication, for example, wired communication standards, such as Ethernet (registered trademark), or wireless communication standards, such as Wi-Fi or a LAN, are used.

FIG. 8 illustrates the user information 63A. As shown in FIG. 8, in the storage 63, account information of each user is stored and authorization information is also stored by the type of prohibition mark as the user information 63A.

For example, for user A shown in FIG. 8: when the type of prohibition mark is "confidential", processing is "prohibited"; when the type of prohibition mark is "limited", processing is also "prohibited"; and when the type of prohibition mark is "in-house", processing is "allowed".

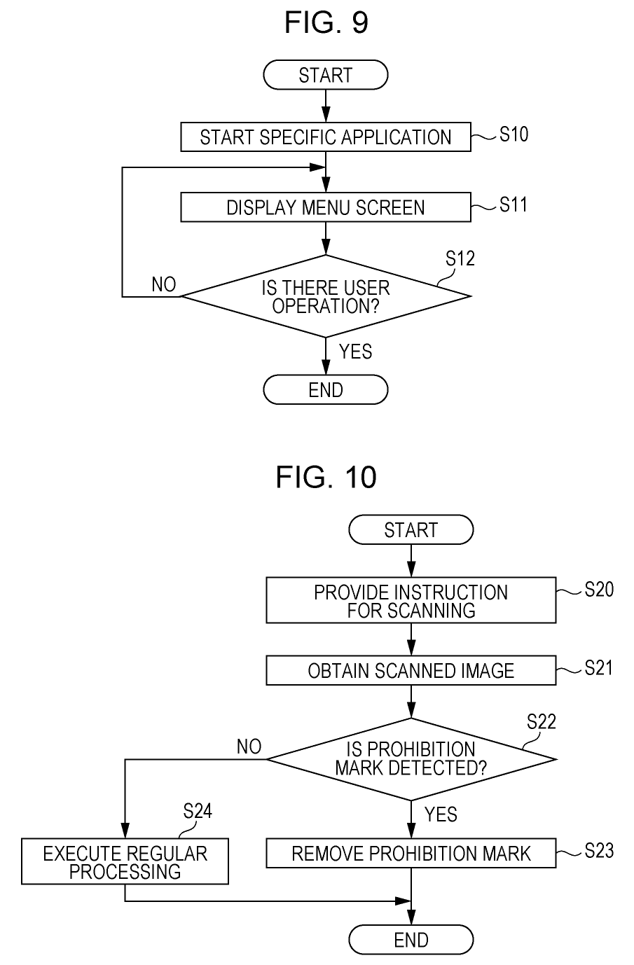

FIG. 9 is a first flowchart illustrating a procedure of specific processing executed by the user terminal 40. The processing shown in FIG. 9 is started in response to a user tapping the user terminal 40 on the NFC portion of the image processing device 20. Then, the Wi-Fi-related information 22C is sent from the image processing device 20 to the user terminal 40 by NFC communication.

In step S10, the CPU 41 checks the Wi-Fi-related information 22C and starts the specific application 42A stored in the storage 42. The CPU 41 then proceeds to step S11.

In step S11, the CPU 41 displays on the display 45 a menu screen for executing image processing on a document that is set in the image processing device 20. This menu includes options, such as "scan" and "print". The CPU 41 then proceeds to step S12.

In step S12, the CPU 41 determines whether the user has input an operation for executing image processing. If the CPU 41 has determined that a user operation is received (YES in step S12), it finishes the processing in FIG. 9 and proceeds to the next processing for the selected type of image processing. If the CPU 41 has determined that a user operation is not received (NO in step S12), it returns to step S11. The user may input an operation by pressing a graphical user interface (GUI) button representing "scan" or "print" displayed on the menu screen, for example.

FIG. 10 is a second flowchart illustrating the procedure of specific processing executed by the user terminal 40. The processing in FIG. 10 is executed following that in FIG. 9.

In step S20, the CPU 41 instructs the image processing device 20 to scan the document for which the user has provided an instruction to execute image processing. The CPU 41 then proceeds to step S21.

In step S21, the CPU 41 obtains from the image processing device 20 a scanned image generated by scanning the document. The scanned image is transferred from the image processing device 20 to the user terminal 40 via wireless communication, such as Wi-Fi. The CPU 41 then proceeds to step S22.

In step S22, the CPU 41 determines whether the obtained scanned image contains a prohibition mark which indicates that the document is a confidential document. More specifically, the CPU 41 checks for a special mark or a digital watermark, for example, by the application of an image analysis algorithm to the document. If the CPU 41 has determined that a prohibition mark is detected (YES in step S22), it proceeds to step S23. If the CPU 41 has determined that a prohibition mark is not detected (NO in step S22), it proceeds to step S24.

In step S23, the CPU 41 removes the prohibition mark from the scanned image. Removing of the prohibition mark is performed by specific filtering processing or alteration of a digital watermark, for example. The CPU 41 then finishes the processing in FIG. 10 and proceeds to the next processing.

In step S24, the CPU 41 executes regular image processing. When image processing is "print", the CPU 41 sends a print instruction to the image processing device 20 and causes it to perform print processing. When image processing is "scan", the CPU 41 sends the scanned image to a specified storage device (the server 60, for example) and causes the storage device to perform storage processing. The CPU 41 then finishes the processing in FIG. 10.

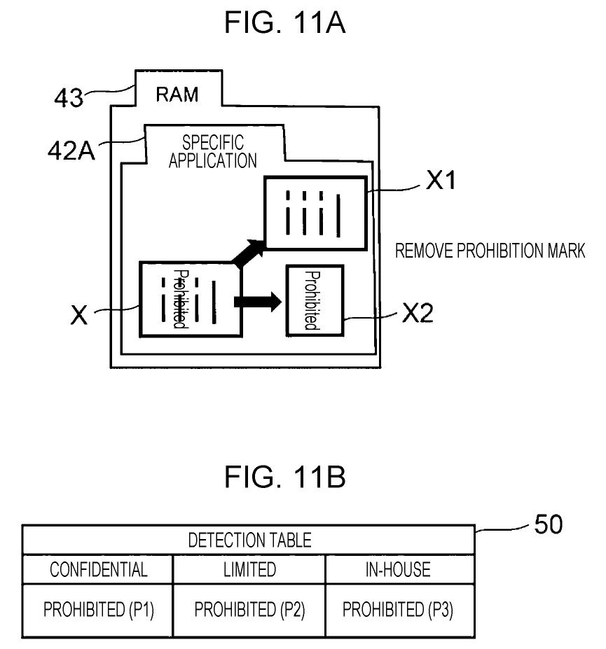

FIG. 11A illustrates a visual image for explaining an execution process of image processing in the user terminal 40.

In the RAM 43 of the user terminal 40, the specific application 42A is loaded. The specific application 42A has a function of determining whether a scanned image X contains a prohibition mark. The scanned image X is not stored in the storage 42, but is merely temporarily processed in the memory, thereby preventing a leakage of image data.

The CPU 41 determines whether the scanned image X contains a prohibition mark by referring to a detection table 50 stored in the specific application 42A. FIG. 11B illustrates an example of the detection table 50. The detection table 50 includes information indicating the type of prohibition mark by pattern. For example, the types of prohibition marks are classified as follows. If the pattern representing the word "prohibited", which is digital watermark information, is P1, the type of prohibition mark is "confidential". If the pattern is P2, the type of prohibition mark is "limited". If the pattern is P3, the type of prohibition mark is "in-house".

If a mark X2 is detected in the scanned image X as the prohibition mark, the specific application 42A removes the mark X2 and generates image data X1 without prohibition mark.

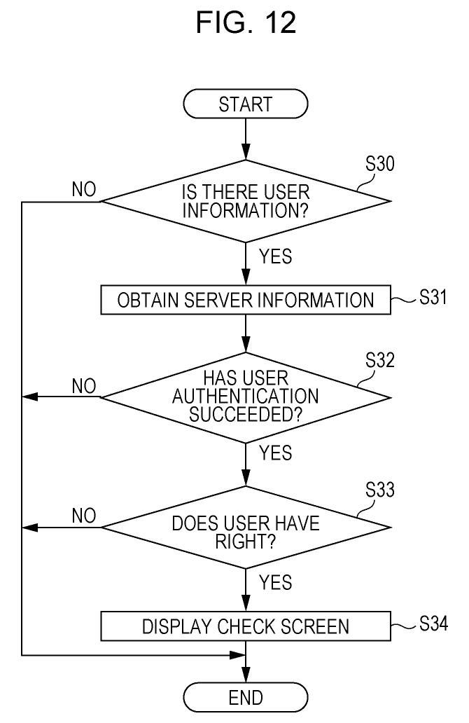

FIG. 12 is a third flowchart illustrating the procedure of specific processing executed by the user terminal 40. The processing in FIG. 12 is executed following that in FIG. 10.

In step S30, the CPU 41 checks the presence or the absence of user information of the user having scanned the document. If the CPU 41 has determined the presence of user information (YES in step S30), it proceeds to step S31. If the CPU 41 has determined the absence of user information (NO in step S30), it terminates the processing. In one example, if account information corresponding to the user information 42B is registered in the specific application 42A, the CPU 41 determines the presence of user information.

In step S31, the CPU 41 instructs the image processing device 20 to send the server information 22B and receives it from the image processing device 20. The CPU 41 then proceeds to step S32.

In step S32, the CPU 41 conducts user authentication by using the obtained server information 22B and determines whether user authentication has succeeded. If the CPU 41 has determined that user authentication has succeeded (YES in step S32), it proceeds to step S33. If the CPU 41 has determined that user authentication has failed (NO in step S32), it terminates the processing. In one example, if account information of the user having scanned the document is not included in the registration information recorded in the server information 22B, the CPU 41 determines that user authentication has failed.

In step S33, the CPU 41 determines whether the user having scanned the document has the right to execute processing at the level of confidentiality set for the document. The CPU 41 makes this determination by checking authorization information of the corresponding user among individual users recorded in the user information 63A. If the CPU 41 has determined that the user has the right (YES in step S33), it proceeds to step S34. If the CPU 41 has determined that the user has no right (NO in step S33), it terminates the processing. If the CPU 41 has determined that the user has no right, it displays on the display 45 an error screen indicating that processing to be executed for a confidential document (hereinafter such processing may simply be called confidential document processing) is not permitted and notifies the user that the user has no right to execute processing at the level of confidentiality set for the document.

In step S34, the CPU 41 displays on the display 45 a check screen indicating that the user is permitted to execute confidential document processing and checks with the user whether to execute processing. On the check screen, the level of confidentiality set for the scanned image, points to be noted when executing processing, and a final approval button, for example, are displayed. The CPU 41 then finishes the processing in FIG. 12 and proceeds to the next processing.

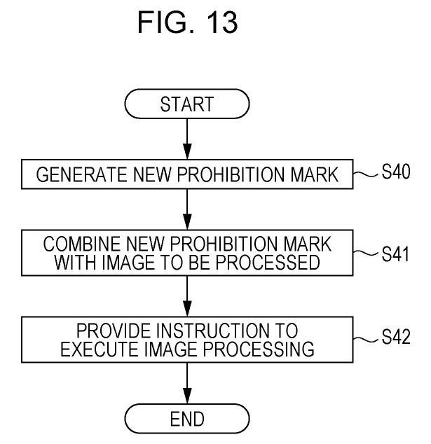

FIG. 13 is a fourth flowchart illustrating the procedure of specific processing executed by the user terminal 40. The processing in FIG. 13 is executed following that in FIG. 12 in response to the final approval button being operated on the check screen. The operation performed on the final approval button is an example of a predetermined operation performed on a display in an exemplary embodiment of the disclosure.

In step S40, the CPU 41 generates a new prohibition mark that contains identification information for identifying a user to execute confidential document processing. The prohibition mark contains the encrypted identification information, such as a user ID of the user to execute processing, processing date and time, authentication results, and confidentiality level. The CPU 41 then proceeds to step S41.

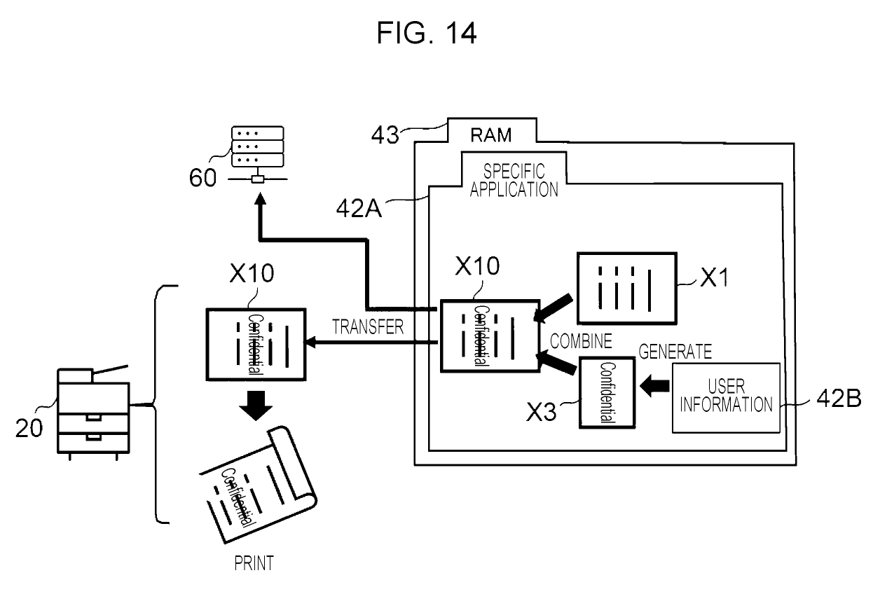

In step S41, the CPU 41 executes combining processing for embedding the generated new prohibition mark in the image which is to undergo confidential document processing. In the example in FIG. 14, which will be discussed later, a new prohibition mark is embedded in the image data X1 which is generated by removing the mark X2 from the scanned image X. In the combining processing, a digital watermark technology or an image encoding technology is used, and the identification information may be embedded in the image without being visible to the user. The CPU 41 then proceeds to step S42.

In step S42, the CPU 41 instructs the image processing device 20 to execute image processing on the image data X1 having the new prohibition mark embedded therein, and more specifically, execution data X10 (see FIG. 14), which will be discussed later. The image processing to be executed includes printing of the data or storing of the data in a specified location. In the case of printing of the data, the CPU 41 sends a print instruction to the image processing device 20 and causes it to print the combined image. In the case of storing of the data, the CPU 41 sends the execution data X10 to the server 60 and causes it to store the execution data X10, together with log information. The CPU 41 then finishes the processing in FIG. 13 and proceeds to the next processing.

FIG. 14 illustrates a visual image for explaining an execution process of generation processing of a new prohibition mark in the user terminal 40.

As illustrated in FIG. 14, the specific application 42A has a function of generating a mark X3, which is a new prohibition mark, by referring to the user information 42B of a user to execute confidential document processing. The mark X3 contains identification information for identifying the user to execute the confidential document processing, such as the user ID of this user. The mark X3 is embedded in the image data X1 without being visible to the user by utilizing a digital watermark technology, for example, and indicates information of the word "confidential".

The specific application 42A combines the generated mark X3 with the image data X1 so as to generate the execution data X10 that executes image processing. With this operation, a prohibition mark is reassigned, which makes it possible to execute suitable image processing while securing traceability.

The specific application 42A also has a function of providing an instruction to execute image processing. In the case of printing of data, the specific application 42A sends the execution data X10 to the image processing device 20 and causes it to print the data. In the case of scanning of data, the specific application 42A sends the execution data 10A to the server 60 to cause it to store the execution data 10A, together with log information. Basically, scan data of a confidential document can be stored only in a storage server, which is a specified server 60. According to the necessity, however, scan data of a confidential document may be stored as a file in a server 60 other than a storage server.

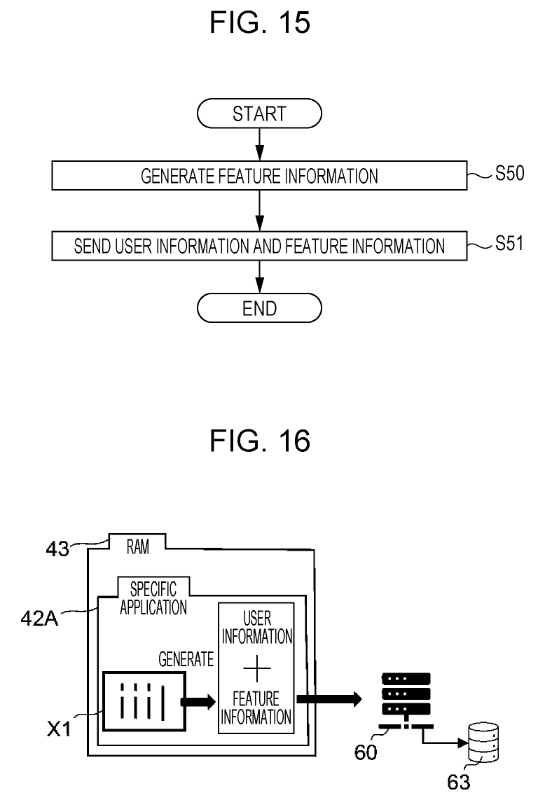

FIG. 15 is a fifth flowchart illustrating the procedure of specific processing executed by the user terminal 40. The processing in FIG. 15 is executed following that of FIG. 13.

In step S50, the CPU 41 generates feature information indicating the features of an image which is to undergo confidential document processing, and more specifically, the features of the image data X1. The feature information is the image which is to undergo processing, a reduced image of this image, or feature vectors of this image. The CPU 41 then proceeds to step S51.

In step S51, the CPU 41 sends the user information 42B concerning the user having printed or stored a confidential document and also sends the generated feature information to the server 60. For example, as the user information 42B, the CPU 41 sends the user ID included in the account information of the user to the server 60. The server 60 then stores the data sent from the user terminal 40 in the storage 63 and manages the data by linking the user information 42B and the feature information with each other. The CPU 41 then completes the specific processing. The storage 63 is an example of a storage of an exemplary embodiment of the disclosure.

FIG. 16 illustrates a visual image for explaining an execution process of generation processing of feature information in the user terminal 40.

As illustrated in FIG. 16, the specific application 42A has a function of generating feature information based on the image data X1 generated by removing the mark X2 from the scanned image X. The feature information is the image of the image data X1, a reduced image of this image, or feature vectors of this image. Generating feature information makes it possible to detect the falsification of a document and secure the traceability.

The specific application 42A also sends the user information 42B and the generated feature information to the server 60. The user information 42B includes the user ID, for example, which makes it possible to record who has processed which document. The server 60 stores the received data in the storage 63 and manages the data by linking the user information 42B and the feature information with each other.

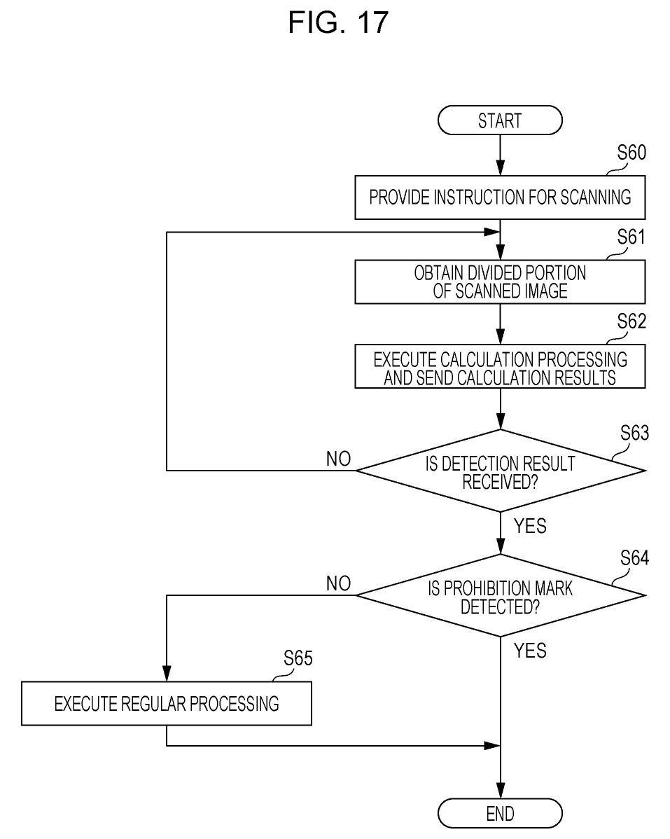

FIG. 17 is a sixth flowchart illustrating the procedure of specific processing executed by the user terminal 40. The processing in FIG. 17 is executed following that of FIG. 9 and is a variation of the processing in FIG. 10.

In step S60, the CPU 41 instructs the image processing device 20 to scan the document for which the user has provided an instruction to execute image processing. In response to this instruction, the image processing device 20 generates a scanned image from the document and divides the scanned image into a predetermined number of portions of image data. The CPU 41 then proceeds to step S61.

In step S61, the CPU 41 obtains a divided portion of the scanned image from the image processing device 20. The CPU 41 then proceeds to step S62.

In step S62, the CPU 41 executes predetermined calculation processing on the obtained divided portion of the scanned image and sends calculation results to the image processing device 20. The CPU 41 then proceeds to step S63.

In step S63, the CPU 41 determines whether a detection result of a prohibition mark is received from the image processing device 20. If the CPU 41 has determined that a detection result is received (YES in step S63), it proceeds to step S64. If the CPU 41 has determined that a detection result is not received (NO in step S63), it returns to step S61 and re-executes it.

In step S64, the CPU 41 determines whether the detection result indicates that a prohibition mark is detected. If the CPU 41 has determined that the detection result indicates that a prohibition mark is detected (YES in step S64), it finishes the processing in FIG. 17 and proceeds to that in FIG. 12. If the CPU 41 has determined that the detection result does not indicate that a prohibition mark is detected (NO in step S64), it proceeds to step S65.

In step S65, the CPU 41 executes regular image processing. The CPU 41 then finishes the processing in FIG. 17.

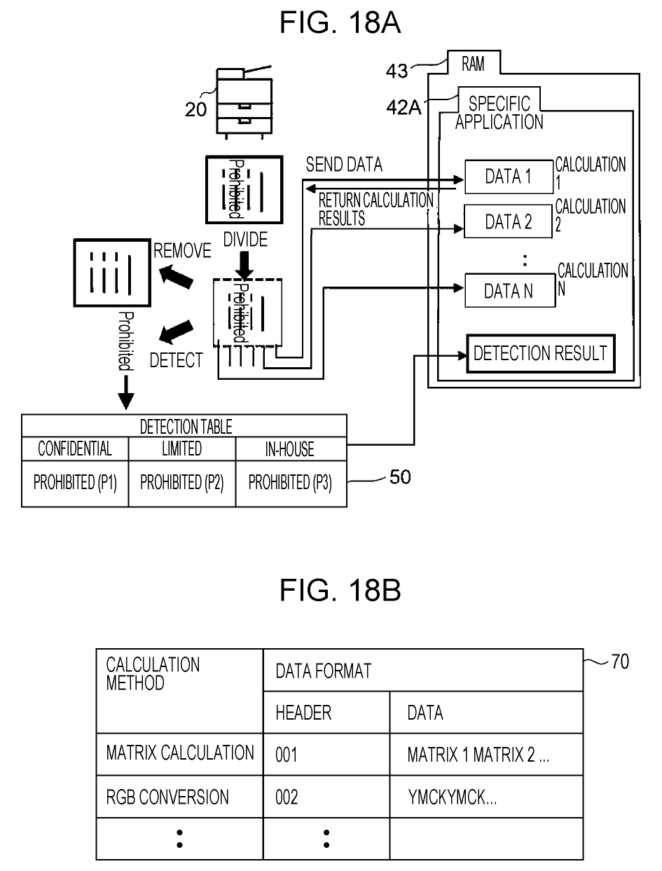

FIG. 18A illustrates a visual image for explaining an execution process of image processing in the user terminal 40 and the image processing device 20.

As illustrated in FIG. 18A, the image processing device 20 divides a scanned image into a predetermined number of portions and generates individual pieces of divided data (data 1, data 2, ..., and data N). As a result of this processing, the image data is divided into small pieces of data so that the user terminal 40 can execute parallel processing.

The specific application 42A stored in the user terminal 40 refers to calculation information 70, such as that illustrated in FIG. 18B, and executes calculation processing, such as matrix calculation and RGB conversion, on the individual divided portions of image data obtained from the image processing device 20. The calculation information 70 is stored in the specific application 42A, and the specific application 42A selects suitable calculation processing in accordance with the type of image or a processing request.

The calculation method and the data format are determined based on the header and the data. For example, matrix calculation (code 001) and RGB conversion (code 002) are selected. The specific application 42A returns the executed calculation results to the image processing device 20. In this manner, the specific application 42A distributes the processing to be executed on the whole image and executes part of the processing so as to reduce the burden on the image processing device 20.

Detecting and removing of a prohibition mark is performed by the image processing device 20. The image processing device 20 refers to the detection table 50 stored in the storage 22 of the image processing device 20 and determines the type of prohibition mark contained in the scanned image. Based on the detection result, the image processing device 20 removes the prohibition mark from the scanned image and generates image data without prohibition mark.

The image processing device 20 also sends the detection result of a prohibition mark to the specific application 42A. If the detection result indicates that a prohibition mark is detected, the image processing device 20 sends the image data without prohibition mark to the specific application 42A, together with the detection result, thereby allowing the specific application 42A to execute the subsequent processing. In the example in FIG. 18A, a general-purpose calculation service is provided, and calculation data and a detection algorithm are first divided and are then individually processed, thereby preventing the whole detection algorithm from being identified from an individual calculation unit. This configuration makes it possible to distribute calculation processing to be executed and also to reduce the risk of a leakage of a highly confidential detection algorithm.

As described above, in the user terminal 40, the CPU 41 obtains a scanned image of a document from the image processing device 20. If the CPU 41 detects from the scanned image that the document is a confidential document, it causes the display 45 to display information regarding whether the execution of confidential document processing is permitted or prohibited in accordance with the right granted to a user having scanned the document using the image processing device 20.

In the user terminal 40, if the execution of the confidential document processing is permitted, the CPU 41 embeds identification information for identifying a user who is to execute the confidential document processing in an image to undergo this processing.

In the user terminal 40, the identification information is digital watermark information. The digital watermark information is embedded in an image to undergo confidential document processing so as not to be visible to a user and is detectable by image processing.

In the user terminal 40, upon receiving a predetermined operation on the display 45, the CPU 41 provides an instruction to print or store an image which is to undergo confidential document processing.

In the user terminal 40, the CPU 41 causes the storage 63 to store the user information 42B and the feature information by linking them with each other. The user information 42B is about a user having printed or stored an image to undergo confidential document processing. The feature information indicates the features of an image to undergo confidential document processing.

In the user terminal 40, the feature information is the image to undergo processing, a reduced image of this image, or feature vectors of this image.

### Others

In the above-described exemplary embodiment, the allocation of processing executed by the image processing device 20 and that by the user terminal 40 may be dynamically adjusted in accordance with the charging status of the user terminal 40.

More specifically, the CPU 41 of the user terminal 40 monitors in real time at least one of the amount of charge remaining, heat emission state, and charging speed, and based on the monitoring results, the CPU 41 optimally distributes the processing load between the user terminal 40 and the image processing device 20. For example, if the amount of charge remaining is smaller than a predetermined threshold, the CPU 41 may transfer part of the confidential document processing to the image processing device 20 so as to reduce the burden on the user terminal 40. If the amount of charge remaining is larger than or equal to the predetermined threshold, the CPU 41 may execute the entire confidential document processing in the user terminal 40.

In the above-described exemplary embodiment, the operation log of the image processing device 20 may be analyzed, and the processing load may suitably be distributed between the user terminal 40 and the image processing device 20 by taking some factors into account, such as the processing capabilities of the user terminal 40 and the network connection status. More specifically, log data, such as the past processing history, network delay, and user operation history, is recorded in the storage 22 of the image processing device 20, and the CPU 41 of the user terminal 40 obtains the log data and analyzes it. Based on the analysis results, the CPU 41 controls in real time the most suitable allocation of processing to optimize the processing load.

For example, if the network communication speed is lower than a predetermined threshold, the CPU 41 may execute the entire confidential document processing in the user terminal 40. If the network communication speed is higher than or equal to the predetermined threshold, the CPU 41 may transfer part of the confidential document processing to the image processing device 20 so as to reduce the load on the user terminal 40.

In the above-described exemplary embodiment, information on an NFC tag embedded in a document which is to undergo confidential document processing may be obtained, and based on this information, a processing load between the user terminal 40 and the image processing device 20 may suitably be distributed. More specifically, the communication unit 24 of the image processing device 20 obtains information on the NFC tag while scanning is being performed and analyzes this information to determine the level of processing to be executed. For example, if the confidential information level is set such that level A, level B, and level C have higher level of confidentiality in descending order, the CPU 21 may suitably allocate the processing load in the following manner. If the confidential information level is level A, the CPU 21 causes the image processing device 20 to execute the entire confidential document processing and does not send data to the user terminal 40. If the confidential information level is level B, the CPU 21 transfers part of the confidential document processing to the user terminal 40 to distribute the processing load. If the confidential information level is level C, the CPU 21 may instruct the user terminal 40 to execute the entire confidential document processing.

In the above-described exemplary embodiment, determination regarding whether to permit the execution of confidential document processing may be dynamically made, based on user authentication information. More specifically, the CPU 41 of the user terminal 40 performs user verification by using a combination of biometric authentication, such as finger print recognition and face recognition, and behavioral authentication, such as handwriting and walking pattern. For example, if a user to be verified is an administrator user, the CPU 41 may allow the user to execute confidential document processing. If a user to be verified is a general user, the CPU 41 limits the execution of confidential document processing, such as the user may require approval from the administrator user.

In the above-described exemplary embodiment, the history and the operation tendency of each user may be analyzed, and the user rights regarding the execution of confidential document processing may be dynamically changed. More specifically, the CPU 41 of the user terminal 40 may obtain and analyze the past operation log and processing history of a user, and if an abnormal operation appears to have occurred, an alert may be issued. For example, if confidential document processing is to be executed in an usual time slot, the CPU 41 determines that an unauthorized operation may have been performed and notifies this to the administrator user. In this case, alternatively, the CPU 41 may not allow the user to execute confidential document processing in this time slot. If the continuous execution of confidential document processing by the same user is detected for a short period of time, the CPU 41 may also issue an alert to curb the unauthorized use of confidential information.

"System" in the above-described exemplary embodiment may be constituted by a single device or by multiple devices. For example, the user terminal 40 may be an example of the information processing system of an exemplary embodiment of the disclosure, or the image processing device 20 and the user terminal 40 may be an example of the information processing system of an exemplary embodiment of the disclosure. If the image processing device 20 and the user terminal 40 are an example of the information processing system of an exemplary embodiment of the disclosure, the CPU 21 and the CPU 41 are an example of the processor of an exemplary embodiment of the disclosure.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The product in the above-described exemplary embodiment may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

The present disclosure may include the following aspects.

(((1)))

An information processing system comprising:

a processor configured to:

obtain a scanned image from an image processing device, the scanned image being generated by scanning a document in the image processing device; and

cause, if it is detected from the scanned image that the document is a confidential document, a display to display information regarding whether execution of confidential document processing is permitted or prohibited in accordance with a right granted to a user having scanned the document using the image processing device.

(((2)))

The information processing system according to (((1))), wherein the processor is configured to embed identification information in an image which is to undergo the confidential document processing if the execution of the confidential document processing is permitted, the identification information being information for identifying a user who is to execute the confidential document processing.

(((3)))

The information processing system according to (((2))), wherein the identification information is digital watermark information, the digital watermark information being embedded in the image which is to undergo the confidential document processing so as not to be visible to a user and being detectable by image processing.

(((4)))

The information processing system according to one of (((1))) to (((3))), wherein the processor is configured to provide an instruction to print or store an image which is to undergo the confidential document processing in response to receiving of a predetermined operation on the display.

(((5)))

The information processing system according to (((4))), wherein the processor is configured to store user information and feature information in a storage by linking the user information and the feature information with each other, the user information being information concerning a user having printed or stored the image which is to undergo the confidential document processing, the feature information being information indicating an feature of the image.

(((6)))

The information processing system according to (((5))), wherein the feature information is the image which is to undergo processing, a reduced image of the image, or a feature vector of the image.

(((7)))

An information processing program causing a computer to execute a process, the process comprising:

obtaining a scanned image from an image processing device, the scanned image being generated by scanning a document in the image processing device; and

causing, if it is detected from the scanned image that the document is a confidential document, a display to display information regarding whether execution of confidential document processing is permitted or prohibited in accordance with a right granted to a user having scanned the document using the image processing device.

What is claimed is:

1. An information processing system comprising:
a processor configured to:
obtain a scanned image from an image processing device, the scanned image being generated by scanning a document in the image processing device; and
cause, if it is detected from the scanned image that the document is a confidential document, a display to display information regarding whether execution of confidential document processing is permitted or prohibited in accordance with a right granted to a user having scanned the document using the image processing device.

2. The information processing system according to claim 1, wherein the processor is configured to embed identification information in an image which is to undergo the confidential document processing if the execution of the confidential document processing is permitted, the identification information being information for identifying a user who is to execute the confidential document processing.

3. The information processing system according to claim 2, wherein the identification information is digital watermark information, the digital watermark information being embedded in the image which is to undergo the confidential document processing so as not to be visible to a user and being detectable by image processing.

4. The information processing system according to claim 1, wherein the processor is configured to provide an instruction to print or store an image which is to undergo the confidential document processing in response to receiving of a predetermined operation on the display.

5. The information processing system according to claim 4, wherein the processor is configured to store user information and feature information in a storage by linking the user information and the feature information with each other, the user information being information concerning a user having printed or stored the image which is to undergo the confidential document processing, the feature information being information indicating an feature of the image.

6. The information processing system according to claim 5, wherein the feature information is the image which is to undergo processing, a reduced image of the image, or a feature vector of the image.

7. An information processing method comprising:
obtaining a scanned image from an image processing device, the scanned image being generated by scanning a document in the image processing device; and
causing, if it is detected from the scanned image that the document is a confidential document, a display to display information regarding whether execution of confidential document processing is permitted or prohibited in accordance with a right granted to a user having scanned the document using the image processing device.

8. A non-transitory computer readable medium storing a program causing a computer to execute a process, the process comprising:
obtaining a scanned image from an image processing device, the scanned image being generated by scanning a document in the image processing device; and
causing, if it is detected from the scanned image that the document is a confidential document, a display to display information regarding whether execution of confidential document processing is permitted or prohibited in accordance with a right granted to a user having scanned the document using the image processing device.
